(19) United States
(12) Patent Application Publication
(10) Pub. No.: US 2008/0161567 A1
(43) Pub. Date: Jul. 3, 2008

(54) Metal Complexes

(75) Inventors: Philipp Stoessel, Frankfurt am Main (DE); Rocco Fortte, Frankfurt am Main (DE); Holger Heil, Darmstadt (DE); Horst Vestweber, Gilersberg-Winterscheid (DE); Heinrich Becker, Hofheim (DE)

Correspondence Address: CONNOLLY BOVE LODGE & HUTZ, LLP, P O BOX 2207, WILMINGTON, DE, 19899, US

(73) Assignee: Merck Patent GmbH, Darmstadt (DE)

(21) Appl. No.: 11/814,707

(22) PCT Filed: Jan. 26, 2006
(86) PCT No.: PCT/EP2006/000651

§ 371 Date: Jul. 25, 2007

(30) Foreign Application Priority Data
Feb. 3, 2005 (EP) 05002237.5

(51) Int. Cl. C07F 19/00

(52) U.S. Cl. 546/10

(57) ABSTRACT

The invention relates to novel metal complexes which can be used as functional materials in a series of different applications that can associated with the electronics industry in the broadest sense. The inventive compounds are described by formulas (1) and (1a).

The present invention describes novel materials, the use thereof in electro-luminescent elements, and displays based thereon.

Organometallic compounds, especially Ir and Pt compounds, will in the near future be used as functional materials in a number of different applications which can be ascribed to the electronics industry in the broadest sense, for example in organic electroluminescent devices. The general structure of such devices is described, for example, in U.S. Pat. No. 4,539,507 and U.S. Pat. No. 5,151,629. The market introduction has already taken place here, as confirmed by the car radios from Pioneer and the mobile telephones from Pioneer and SNMD with an “organic display”. Further products of this type are to be introduced shortly.

A development which has taken place in recent years is the use of organometallic complexes which exhibit phosphorescence instead of fluorescence (M. A. Baldo et al., Appl. Phys. Lett. 1999, 75, 4-6). For quantum-mechanical reasons, an up to four-fold increase in energy and power efficiency is possible using organometallic compounds as phosphorescence emitters. Whether this development will be successful depends on whether corresponding device compositions are found which are also able to implement these advantages (triplet emission=phosphorescence compared with singlet emission=florescence) in OLEDs. Essential conditions which may be mentioned here are, in particular, a long operating lifetime and high thermal stability of the complexes.

However, there are still considerable problems requiring urgent improvement in OLEDs which exhibit triplet emission. This also applies, in particular, to the triplet emitter itself. Most of the complexes known in the literature contain ligands based on phenylpyridine or related structures which coordinate to iridium or platinum (for example WO 02/068435, WO 04/026886). This structure is characterised by the absence of a bridge (formula A) or the presence of an alkylene bridge having 2 to 20 C atoms, which may optionally be replaced by heteroatoms, between the two rings (WO 03/000661, formula B).

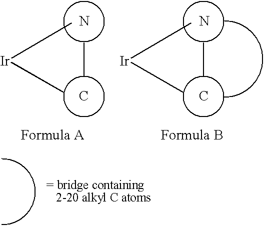

In practice, compounds of this type have some crucial weak points which require improvement:
1. A crucial deficiency is the inadequate thermal stability of the compounds described above. Although, for example, the homoleptic complex fac-tris(2-phenylpyridyl-C²,N)iridium(II) (referred to generally as Ir(PPy)₃) can be vapour-deposited without decomposition during production of the organic electroluminescent device, this vapour-deposition process is, however, only carried out with low vapour-deposition rates, whereas significantly higher sublimation rates and therefore also a significantly higher temperature are required during sublimation for purification of the material. The thermal stability of the materials during sublimation is still inadequate, which results in partial decomposition of the material, associated with contamination of the complex by decomposed components.
2. The operating lifetime is generally still too short, which has to date stood in the way of the introduction of phosphorescent OLEDs into high-quality devices with long lives.
3. Square-planar complexes in particular tend, due to stacking, to form exciplexes, which either extinguish the emission or shift the emission colour in an undesired manner.
4. The complexes frequently have only low solubility in organic solvents, which makes efficient purification by recrystallisation or chromatography much more difficult or prevents it. This applies, in particular, to the purification of relatively large amounts, as required in display manufacture. The brominated complexes in particular, which can be used, for example, for the preparation of polymers, exhibit only low solubility and are therefore difficult to process during polymerisation.

In particular, the simultaneous improvement in the lifetime and thermal stability of the complexes would be advantageous. There is therefore a demand for compounds which do not have the above-mentioned weak points, but are at least equal to the known metal complexes with respect to efficiency and emission colour.

Surprisingly, it has now been found that certain novel compounds which have a bridge with precisely one bridge atom between the two rings have excellent properties as triplet emitters in OLEDs.

Complexes containing ligands of this type have already been mentioned with rhodium (JP 2004/311405, JP 2004/319438), with the respective applications also depicting numerous other rhodium complexes which do not have this bridge or which have other, larger bridges. Particular advantages of the complexes which have precisely one bridge atom between the two rings over the other complexes are not described. This structure is only shown as one possible embodiment alongside numerous others, and no particular advantages are evident with rhodium.

The present invention relates to the compounds of the formula (1)

M(L)ₙ(L′)ₘ(L″)ₒ Formula (1)

containing a sub-structure M(L)ₙ of the formula (2)

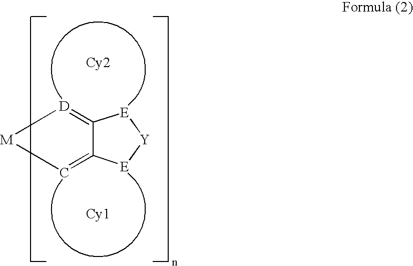

where the following applies to the symbols and indices used:
M is on each occurrence iridium, platinum, palladium, gold, tungsten, rhenium, ruthenium or osmium;
D is, identically or differently on each occurrence, an sp²-hybridised heteroatom having a non-bonding electron pair which coordinates to M;
C is on each occurrence an sp²-hybridised carbon atom which bonds to M;
E is, identically or differently on each occurrence, an sp²-hybridised carbon or nitrogen atom;
Y is, identically or differently on each occurrence, CR₂, C(═O), C(═NR), C(═N—NR₂), C(═CR₂), SiR₂, O, S, S(═O), S(═O)₂, Se, NR, PR, P(═O)R, AsR, As(═O)R or BR;
Cy1 is, identically or differently on each occurrence, an optionally R¹-substituted homo- or heterocycle which bonds to M via an sp²-hybridised carbon atom;
Cy2 is, identically or differently on each occurrence, an optionally R¹-substituted heterocycle which coordinates to M via the atom D;
R is, identically or differently on each occurrence, H, F, CN, a straight-chain alkyl or alkoxy group having 1 to 40 C atoms or a branched or cyclic alkyl or alkoxy group having 3 to 40 C atoms, where in each case one or more non-adjacent CH₂ groups may be replaced by —R²C═CR²—, —C≡C—, Si(R²)₂, Ge(R²)₂, Sn(R²)₂, —O—, —S—, —NR²—, —(C═O)—, —(C═NR²)—, P═O(R²)— or —CONR²— and where one or more H atoms may be replaced by F, or an aromatic or heteroaromatic system or an aryloxy or heteroaryloxy group having 1 to 30 C atoms, each of which may be substituted by one or more radicals R¹; two radicals R here may also form a further aliphatic or aromatic ring system with one another;
R¹ is, identically or differently on each occurrence, H, F, Cl, Br, I, OH, NO₂, CN, N(R²)₂, a straight-chain alkyl or alkoxy group having 1 to 40 C atoms or a branched or cyclic alkyl or alkoxy group having 3 to 40 C atoms, where in each case one or more non-adjacent CH₂ groups may be replaced by —R²C═CR²—, —C≡C—, Si(R²)₂, Ge(R²)₂, Sn(R²)₂, —O—, —S—, —NR²—, —(C═O)—, —(C═NR²)—, —P═O(R²)—COOR²— or —CONR²— and where one or more H atoms may be replaced by F, or an aromatic or heteroaromatic system or an aryloxy or heteroaryloxy group having 1 to 30 C atoms, which may be substituted by one or more non-aromatic radicals R¹, where a plurality of substituents R¹, both on the same ring and also on different rings, may together in turn form a further mono- or polycyclic, aliphatic or aromatic ring system;
R² is, identically or differently on each occurrence, H or an aliphatic or aromatic hydrocarbon radical having 1 to 20 C atoms;
n is 1, 2 or 3;
   the ligands L′ and L″ in formula (1) here are monoanionic, bidentate- chelating ligands; m and o are, identically or differently on each occurrence, 0, 1 or 2.
   n+m+o=2 here for metals with square-planar coordination, for example platinum and palladium, and n+m+o=3 for metals with octahedral coordination, for example iridium.

Hybridisation is taken to mean the linear combination of atomic orbitals. Thus, linear combination of one 2s and two 2p orbitals gives three equivalent sp² hybrid orbitals, which form an angle of 120° to one another. The remaining p orbital is capable of forming a π-bond, for example in an aromatic system.

For the purposes of the present invention, a C₁- to C₄₀-alkyl group, in which individual H atoms or CH₂ groups may also be substituted by the above-mentioned groups, is particularly preferably taken to mean the radicals methyl, ethyl, n-propyl, i-propyl, n-butyl, i-butyl, s-butyl, t-butyl, 2-methylbutyl, n-pentyl, s-pentyl, cyclopentyl, n-hexyl, cyclohexyl, n-heptyl, cycloheptyl, n-octyl, cyclooctyl, 2-ethylhexyl, trifluoromethyl, pentafluoroethyl, 2,2,2-trifluoroethyl, ethenyl, propenyl, butenyl, pentenyl, cyclopentenyl, hexenyl, cyclohexenyl, heptenyl, cycloheptenyl, octenyl, cyclooctenyl, ethynyl, propynyl, butynyl, pentynyl, hexynyl or octynyl, A C₁— to C₄₀-alkoxy group is particularly preferably taken to mean methoxy, ethoxy, n-propoxy, i-propoxy, n-butoxy, i-butoxy, s-butoxy, t-butoxy or 2-methylbutoxy. An aromatic or heteroaromatic system having 1-30 C atoms, which may also in each case be substituted by the above-mentioned radicals R¹ and which may be linked to the aromatic or heteroaromatic ring via any desired positions, is taken to mean, in particular, groups derived from benzene, naphthalene, anthracene, phenanthrene, pyrene, chrysene, perylene, fluoranthene, tetracene, pentacene, benzopyrene, biphenyl, biphenylene, terphenyl, terphenylene, fluorene, spirobifluorene, dihydrophenanthrene, dihydropyrene, tetrahydropyrene, cis- or trans-indenofluorene, furan, benzofuran, isobenzofuran, dibenzofuran, thiophene, benzothiophene, isobenzothiophene, dibenzothiophene, pyrrole, indole, isoindole, carbazole, pyridine, quinoline, isoquinoline, acridine, phenanthridine, benzo-5,6-quinoline, benzo-6,7-quinoline, benzo-7,8-quinoline, phenothiazine, phenoxazine, pyrazole, indazole, imidazole, benzimidazole, naphthimidazole, phenanthrimidazole, pyridimidazole, pyrazinimidazole, quinoxalinimidazole, oxazole, benzoxazole, naphthoxazole, anthroxazole, phenanthroxazole, isoxazole, 1,2-thiazole, 1,3-thiazole, benzothiazole, pyridazine, benzopyridazine, pyrimidine, benzopyrimidine, quinoxaline, pyrazine, phenazine, naphthyridine, azacarbazole, benzocarboline, phenanthroline, 1,2,3-triazole, 1,2,4-triazole, benzotriazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 1,3,5-triazine, 1,2,4-triazine, 1,23-triazine, tetrazole, 1,2,4,5-tetrazine, 1,2,3,4-tetrazine, 1,2,3,5-tetrazine, purine, pteridine, indolizine and benzothiadiazole.

Cy1 and Cy2 are preferably aromatic or heteroaromatic systems. Cy1 and Cy2 here may also contain a plurality of rings which are fused to one another.

Preference is given to compounds of the formula (1) containing a sub-structure M(L)ₙ of the formula (2a)

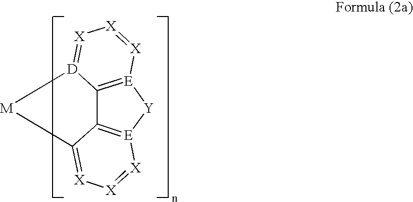

where M, Y, R, R¹, R², L′, L″ and n have the same meaning as described above, and the following applies to the other symbols:
D is, identically or differently on each occurrence, nitrogen or phosphorus;
X is, identically or differently on each occurrence, CR¹, N or P; or (X—X) or (X—X) (i.e. two adjacent X) stands for NR¹, S or O; or (X—X) or (X═X) (i.e. two adjacent X) stands for CR¹, N or P if the symbol E in the corresponding ring stands for N;
E is, identically or differently on each occurrence, C or N, with the proviso that if the symbol E stands for N, precisely one unit X—X (i.e. two adjacent X) in the corresponding ring is equal to CR¹, N or P.

A particularly preferred embodiment of the present invention comprises compounds of the formula (1a)

M(L)ₙ(L′)ₘ(L″)ₒ Formula (1a)

containing at least one sub-structure M(L)ₙ of the formula (2b)

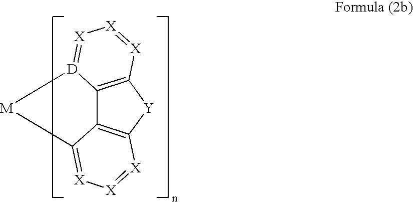

and optionally containing a sub-structure M(L′)ₘ of the formula (3)

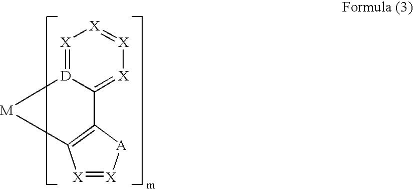

where M, D, R, R¹, R², L″, n, m and o have the same meaning as described above, and furthermore:
X is, identically or differently on each occurrence, CR¹, N or P; or (X—X) or (X—X) (i.e. two adjacent X) stands for NR¹, S or O;
A is, identically or differently on each occurrence, —CR¹═CR¹—, —N═CR¹—, —P═CR¹—, —N═N—, —P═N—, NR¹, O or S;
   with the proviso that each of the two rings is a five- or six-membered ring.

Monoanionic, bidentate ligands L″ according to the invention are 1,3-diketonates derived from 1,3-diketones, such as, for example, acetylacetone, benzoylacetone, 1,5-diphenylacetylacetone, bis(1,1,1-trifluoroacetyl)methane, 3-ketonates derived from 3-ketoesters, such as, for example, ethyl acetoacetate, carboxylates derived from aminocarboxylic acids, such as, for example, pyridine-2-carboxylic acid, quinoline-2-carboxylic acid, glycine, N,N-dimethylglycine, alanine, N,N-dimethylalanine, salicyliminates derived from salicylimines, such as, for example, methylsalicylimine, ethylsalicylimine, phenylsalicylimine, or borates of nitrogen containing heterocyclic ligands which are bonded via a neutral nitrogen atom and an anionic nitrogen ligand, such as, for example, pyridylpyrazoles, pyrridylimidazoles or pyridyltriazoles, such as, for example, tetrakis(1-imidazolyl) borate and tetrakis(1-pyrazolyl) borate.

Preference is given to compounds of the formula (1) and formula (1a) in which the index n=2 or 3, where n=3 is not possible for square-planar complexes. Particular preference is given to compounds in which the index o=0. Very particular preference is given to compounds in which the indices m=o=0. Particularly preferably, n=2 and m=o=0 for square-planar complexes and n=3 and m=o=0 for octahedral complexes. Very particular preference is given to homoleptic complexes, i.e. complexes where m=o=0, in which all ligands present are identical and are also identically substituted. The preference for homoleptic complexes is due to the easier synthetic accessibility.

Preference is given to compounds of the formula (1) and formula (1a) in which the symbol Y stands for CR₂, C(═O), C(═CR₂), O, S, NR, PR, P(═O)R or BR. Particular preference is given to compounds of the formula (1) and formula (1 a) in which the symbol Y stands for CR₂, O, S, NR or P(═O)R.

In a particularly preferred embodiment of the invention, the ligand which produces structures of the formula (2) or formula (2a) or formula (2b) is a spiro compound, where the symbol Y represents the spiro atom, in particular derivatives of azaspirobifluorene, i.e. structures in which the symbol Y stands for CR₂, where the two radicals R stand for substituted or unsubstituted phenyl groups, which form a further ring system with one another. Preference is furthermore given to compounds of the formula (1) and formula (1a) in which the symbol D=N.

Preference is furthermore given to compounds of the formula (1) and formula (1a) in which the symbol X═CR¹ or N, in particular X═CR¹.

Preference is furthermore given to compounds of the formula (1) and formula (1a) in which the following applies to the symbol R¹ for systems which can be subjected to vapour deposition:

R¹ is on each occurrence, identically or differently, H, F, CN, methyl, tertbutyl, phenyl, CF₃ or a fused cyclic alkoxy group having 1 to 4 C atoms.

For compounds of the formula (1) and formula (1a) which are processed from solution and which therefore must have good solubility in organic solvents, at least one of the substituents R and/or R¹ contains an alkyl and/or alkoxy chain having at least four C atoms.

In particular for square-planar complexes, i.e., for example, complexes with platinum or palladium, it is preferred for Y to stand for CR₂ and the radicals R to be bulky, for example to represent a spiro system, since the complexes are sterically screened thereby and the formation of exciplexes is prevented.

Octahedral compounds of the formula (1) and formula (1a) can be in facial and meridional form. The invention relates both to the pure facial form and also to the pure meridional form of the complex and to mixtures comprising both the facial form and the meridional form.

The corresponding ligands which produce sub-structures of the formula (2) or formula (2a) or (2b), and also the ligands L′ and L″, can be prepared by standard organochemical processes, as are familiar to the person skilled in the art of organic synthesis. Suitable reactions for the ligand synthesis of azafluorene derivatives and corresponding azaspirobifluorene derivatives, azacarbazoles, etc., are analogous to the literature (for example A.-S. Rebstock et al., Tetrahedron 2003, 59, 4973-4977 for the synthesis of 4-aza-9-fluorenone; T. Iwaki et al., J. Chem. Soc., Perkin 11999, 1505-1510 for the synthesis of 4-azacarbazole; A. Degl'Innocenti et al., J. Chem. Soc., Perkin 1 1996, 2561-2563 for the synthesis of 4-azadibenzothiophene; W. S. Yue et al, Org. Lett. 2002, 4, 2201-2203 for the synthesis of 4-azadibenzofuran). Azaspirobifluorene can be synthesised from azafluorenone analogously to the synthesis of spirobifluorene from fluorenone.

The invention furthermore relates to the use of ligands which result in sub-structures of the formula (2) or formula (2a) or formula (2b) in the complex, for the preparation of the compounds of the formula (1) or formula (1a) according to the invention.

The metal complexes according to the invention can in principle be pre-pared by various processes; however, the processes described below have proven particularly suitable.

The present invention therefore furthermore relates to a process for the preparation of the metal complex compounds of the formula (1) and formula (1a) by reaction of the corresponding free ligands with metal alkoxides of the formula (4), with metal ketoketonates of the formula (5) or with mono- or polynuclear metal halides of the formula (6), (7) or (8)

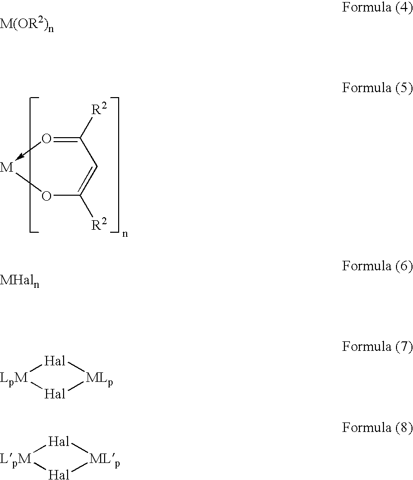

where the symbols M, n and R² have the meanings indicated above, p ˜1 for divalent metals, p=2 for trivalent metals and Hal=F, Cl, Br or I.

It is likewise possible to use metal compounds, in particular iridium compounds, which carry both alkoxide and/or halide and/or hydroxyl radicals and also ketoketonate radicals. These compounds may also be charged. Corresponding iridium compounds which are particularly suitable as starting materials are disclosed in WO 04/085449.

The synthesis of the complexes is preferably carried out as described in WO 02/060910 and in WO 04/085449. Heteroleptic complexes can also be synthesised, for example, as described in WO 05/042548.

These processes enable the compounds of the formula (1) according to the invention to be obtained in high purity, preferably greater than 99% (determined by ¹H-NMR and/or HPLC).

The synthetic methods explained here enable the preparation of, inter alia, structures (1) to (159) shown below for the compounds of the formula (1).

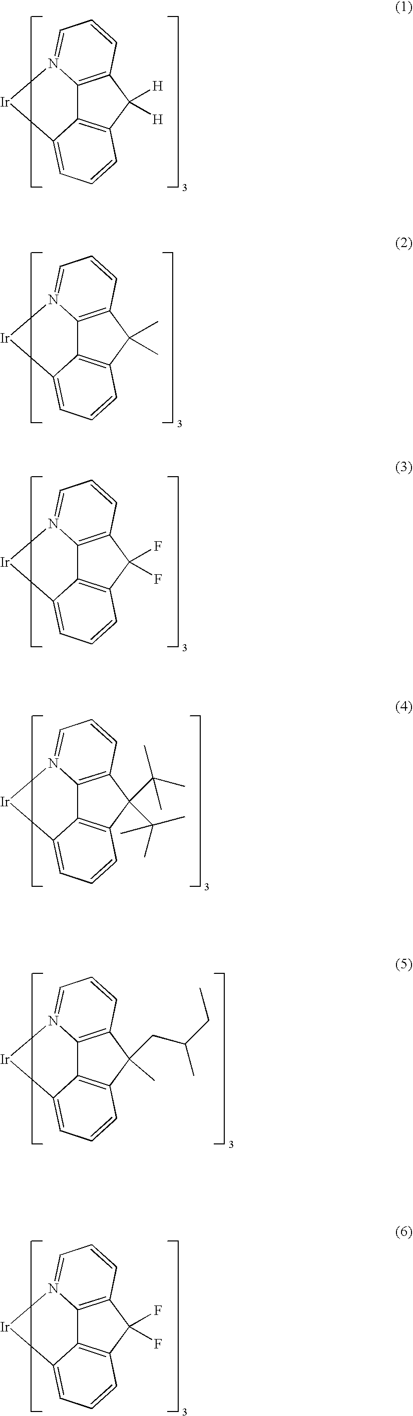

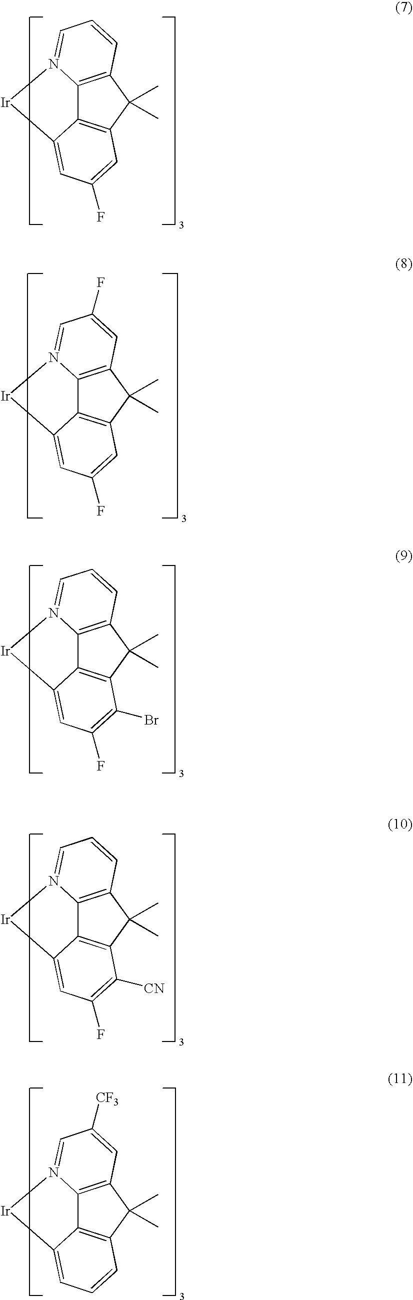

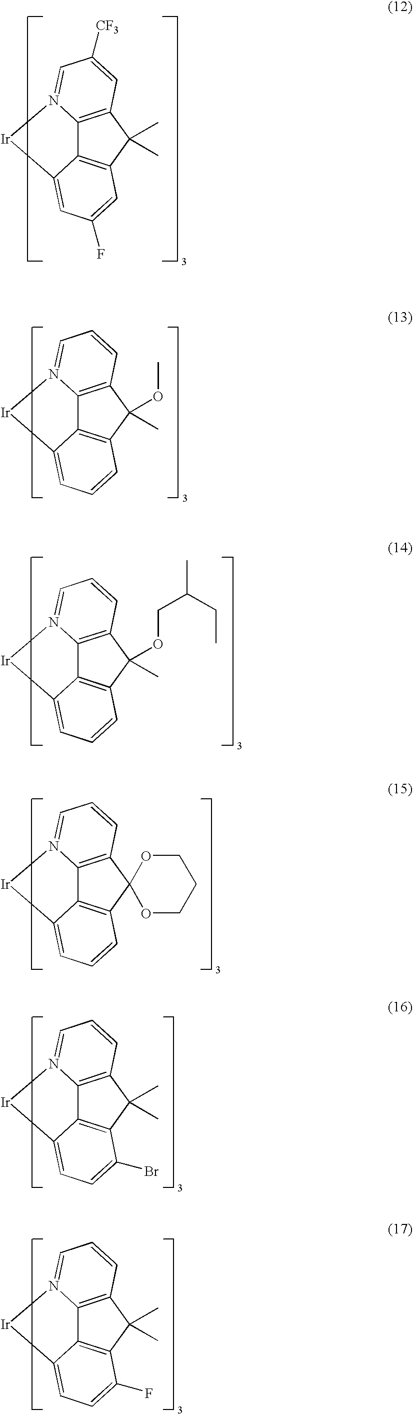

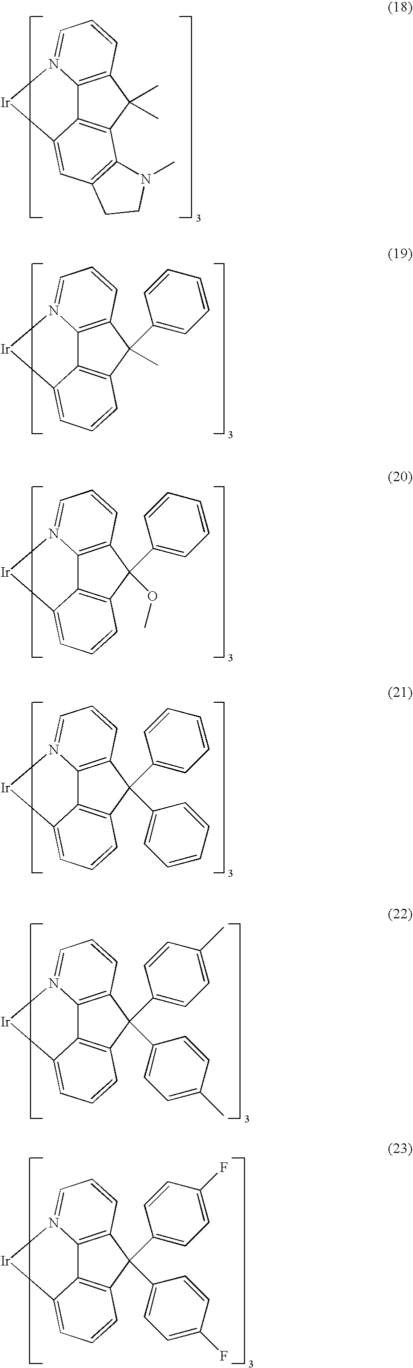

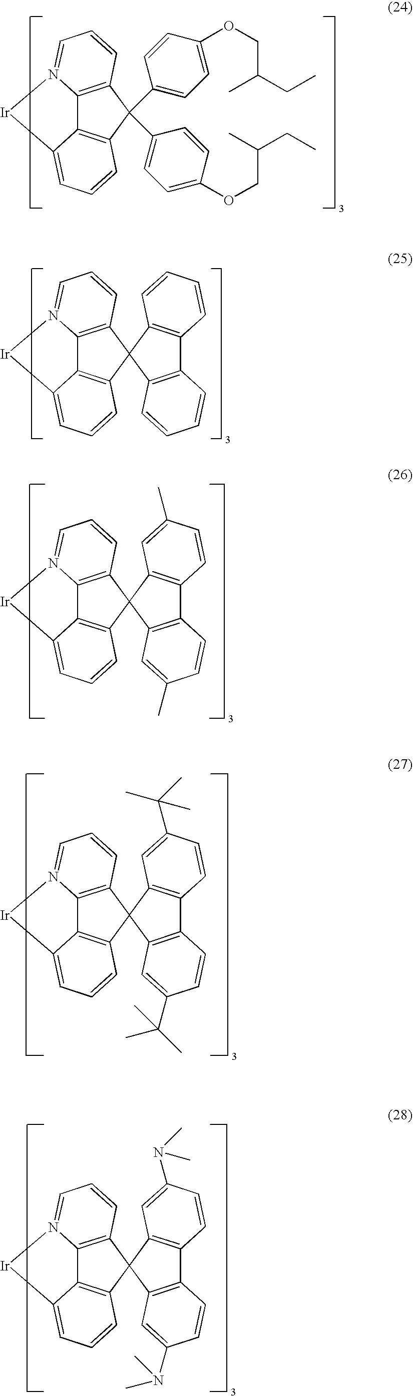

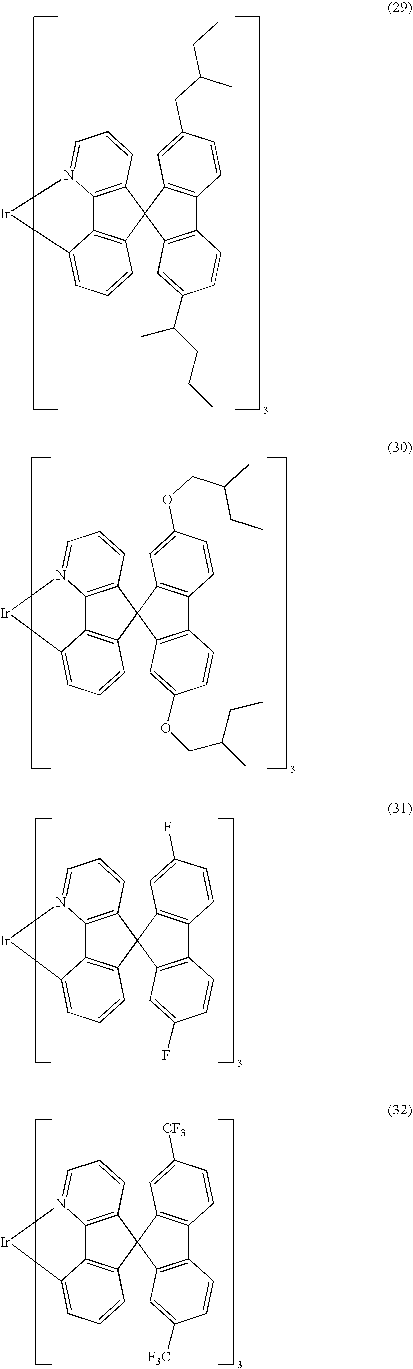

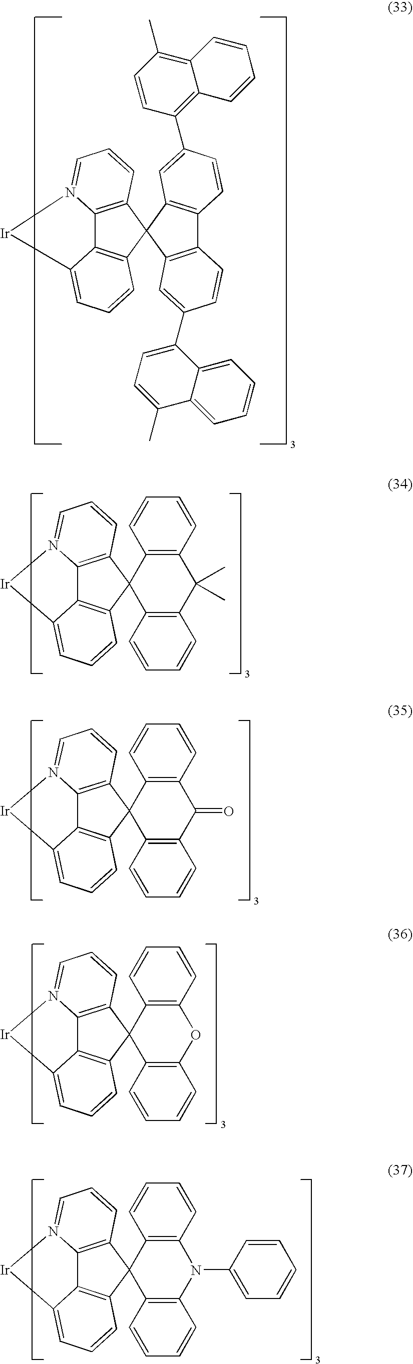

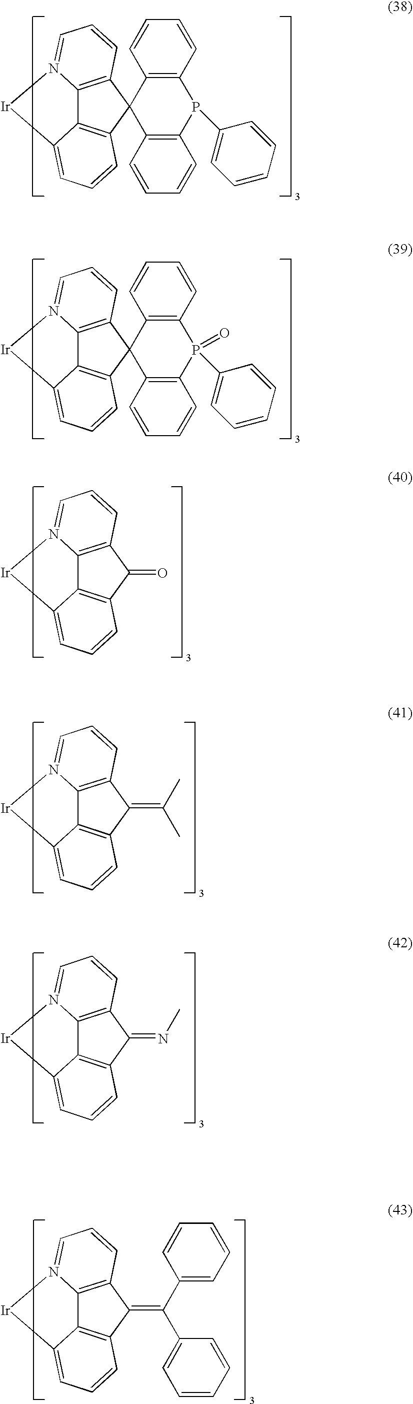

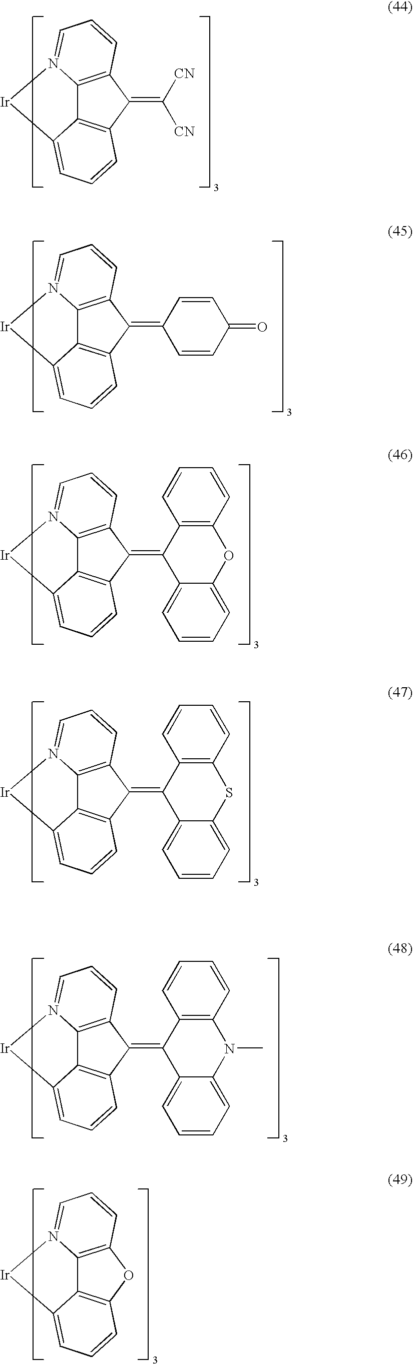

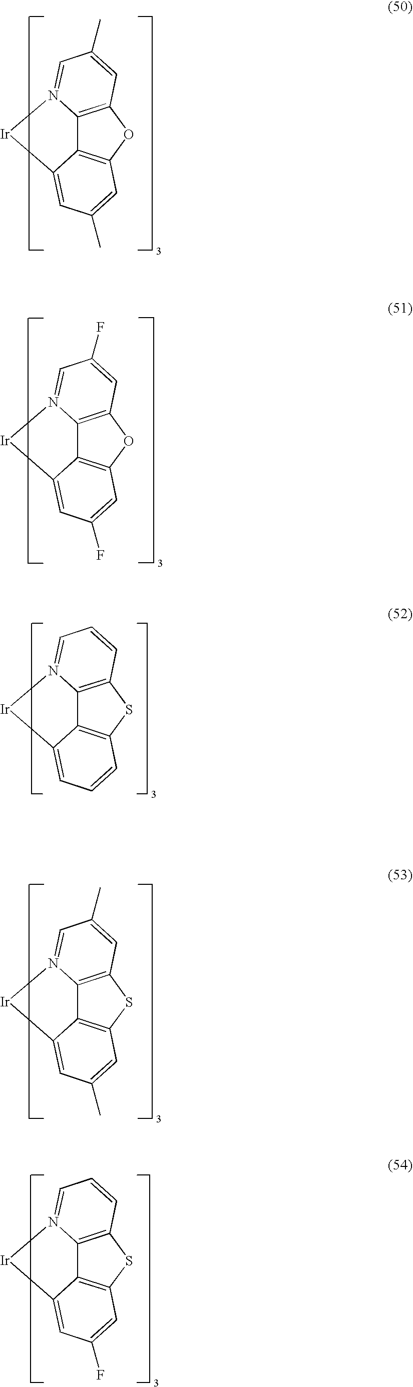

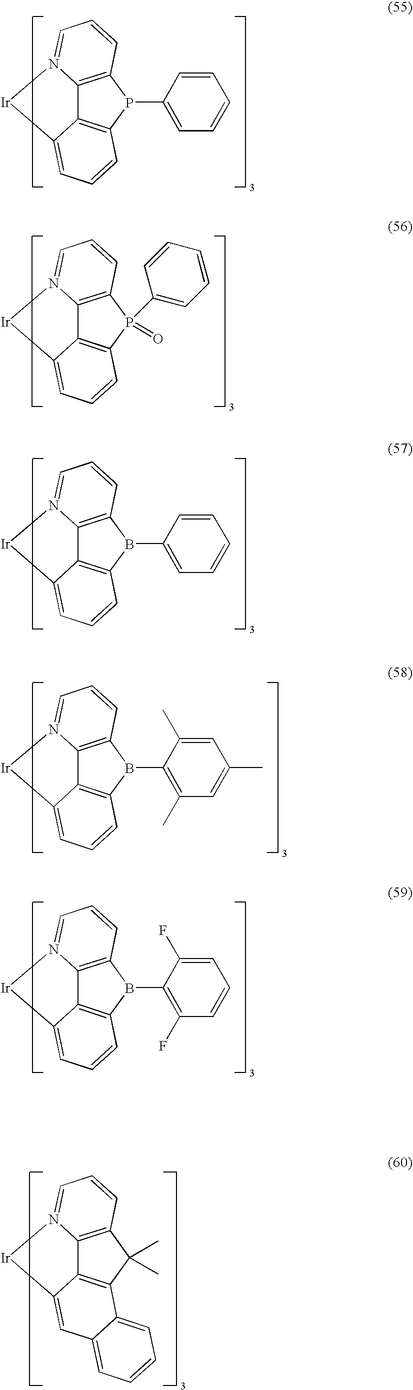

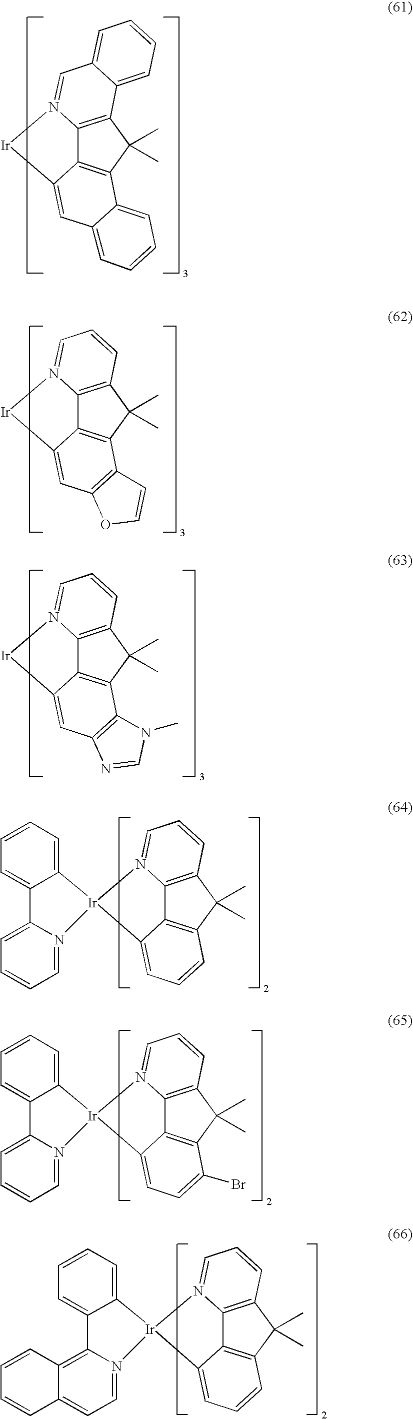

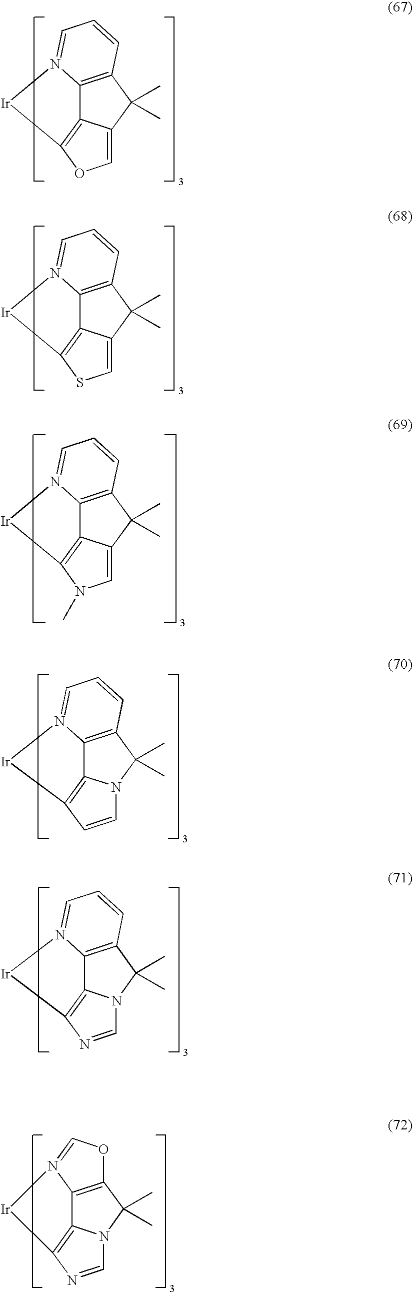

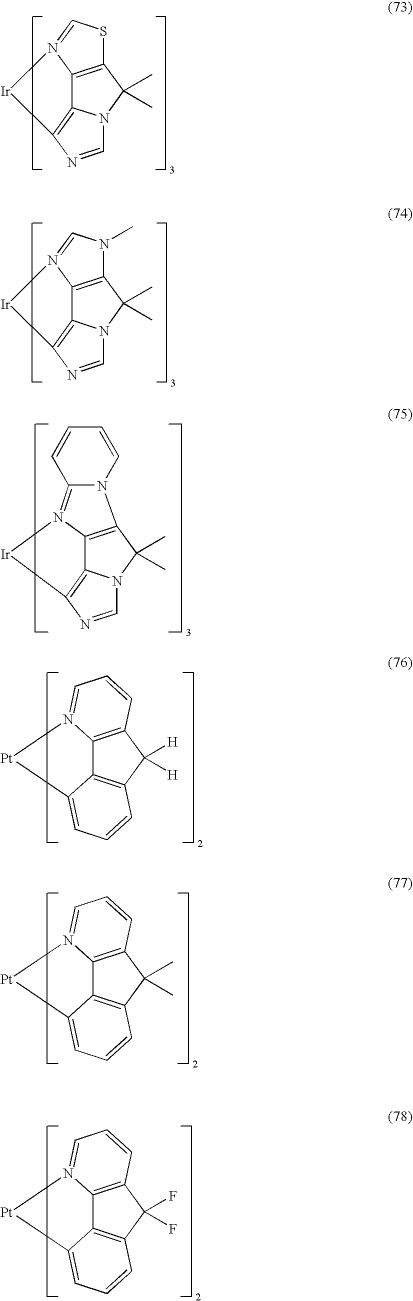

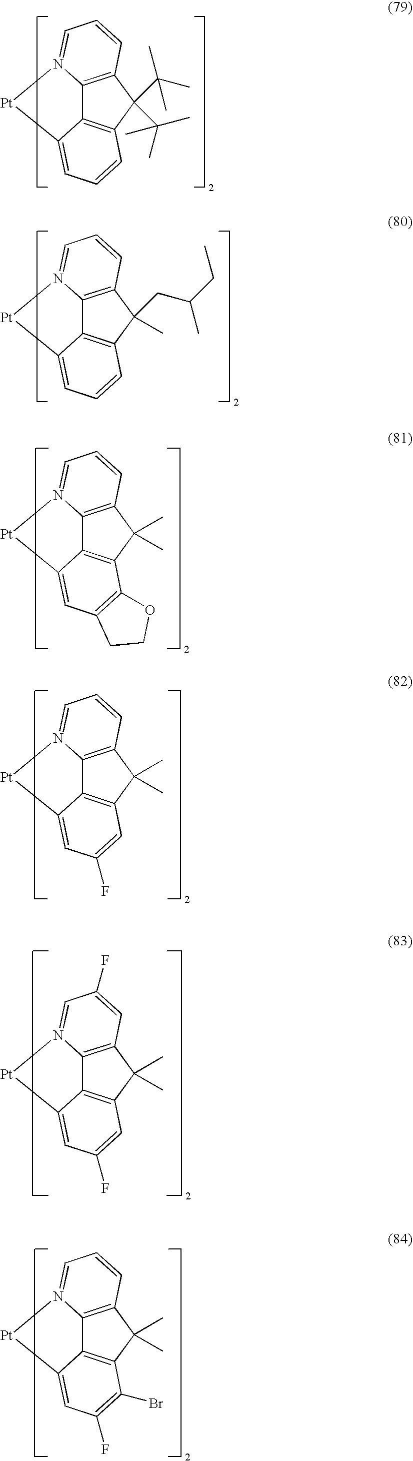

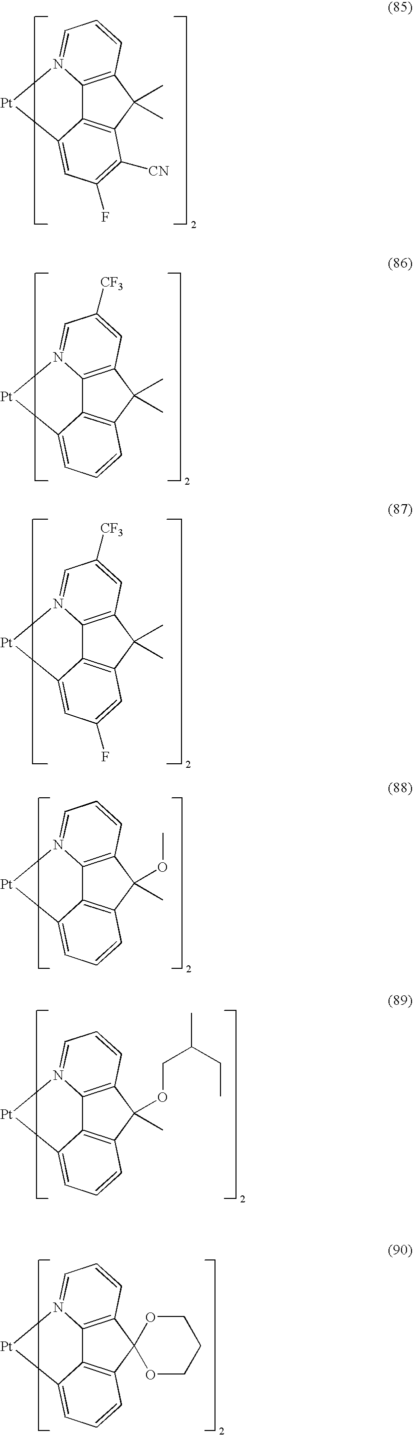

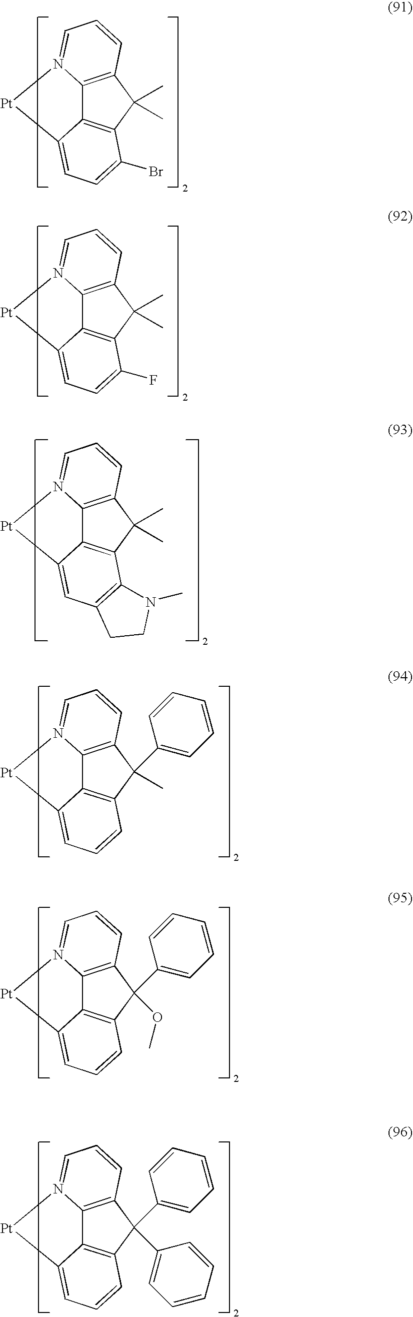

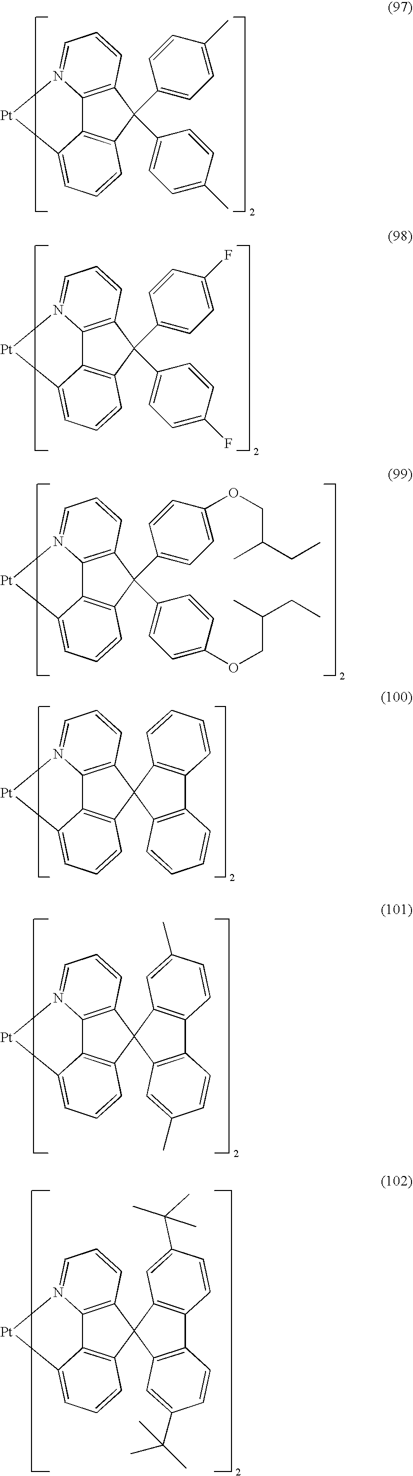

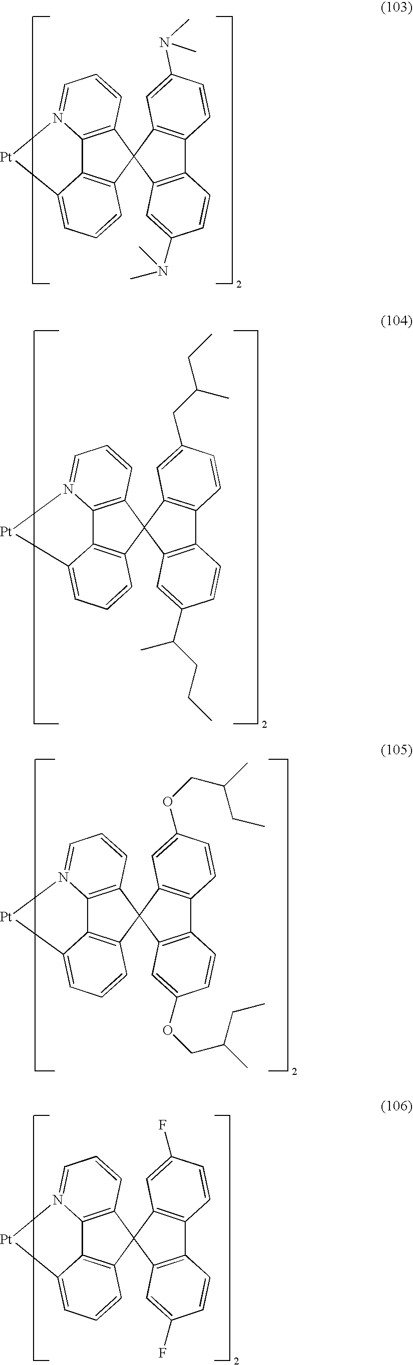

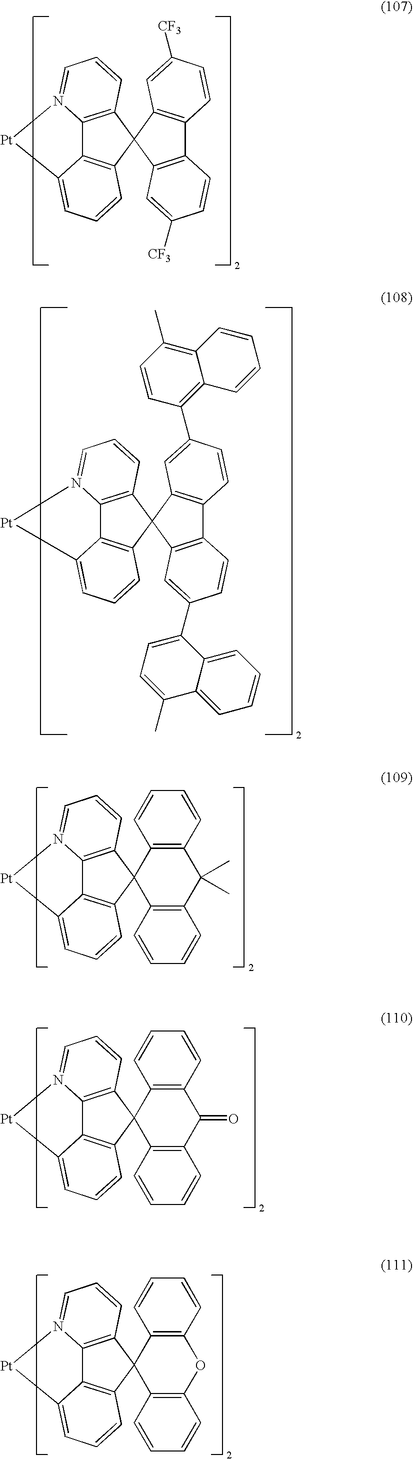

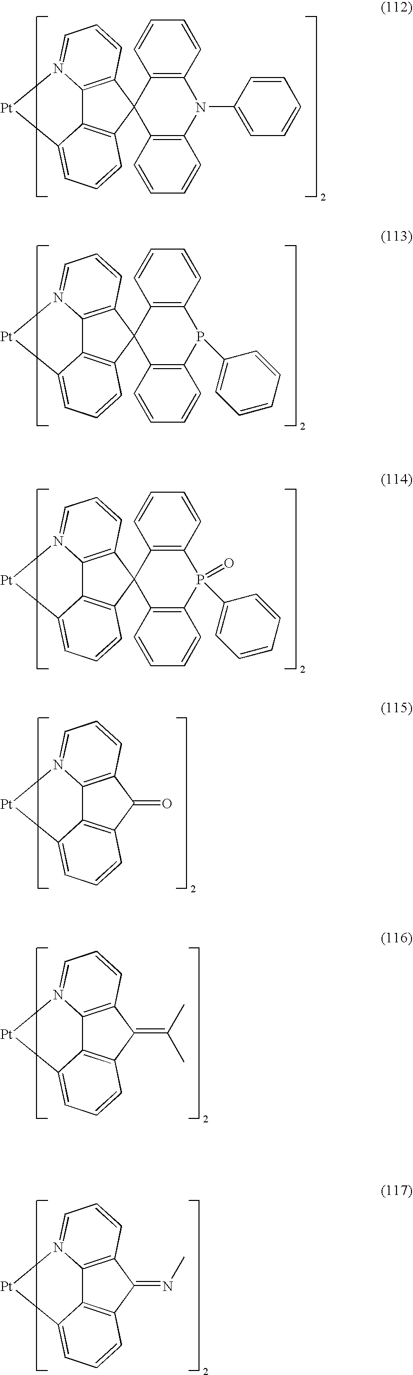

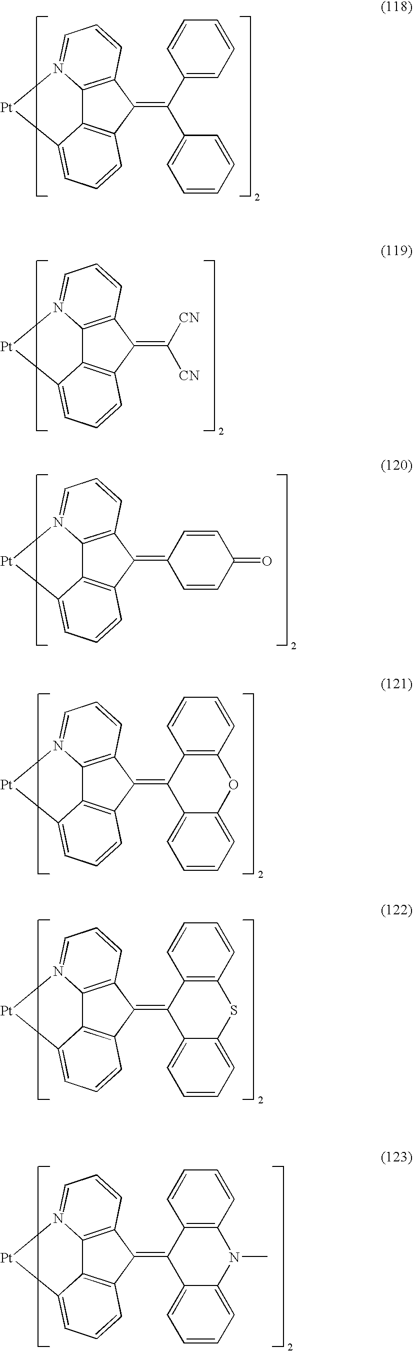

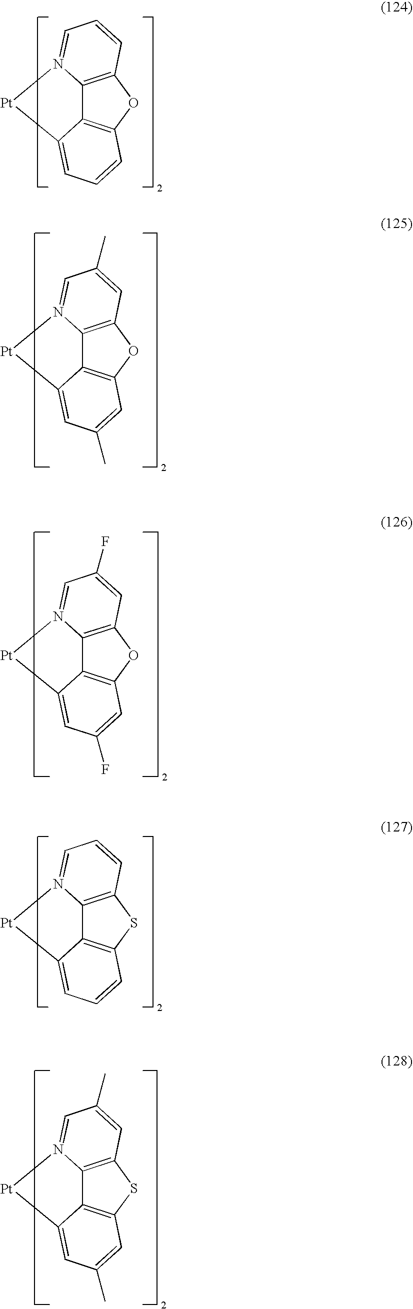

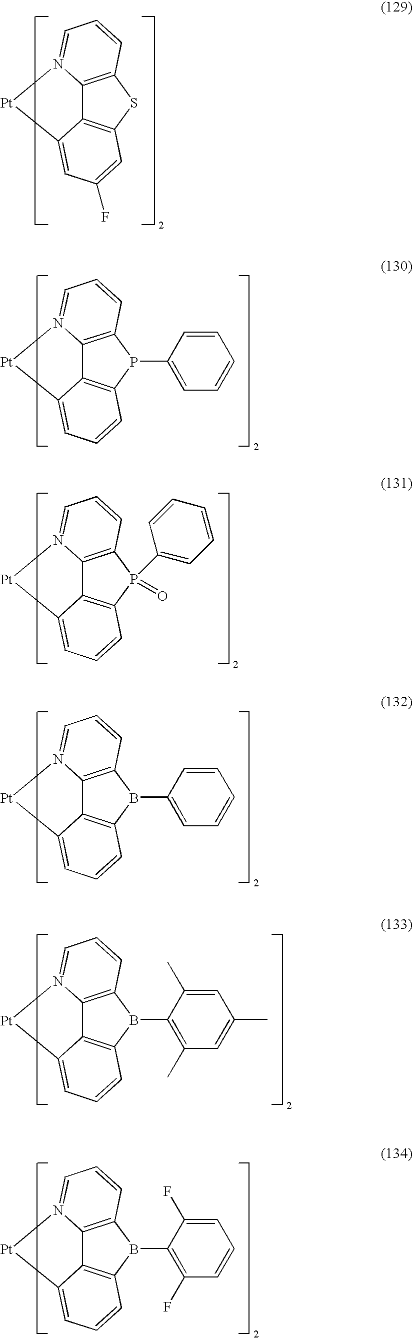

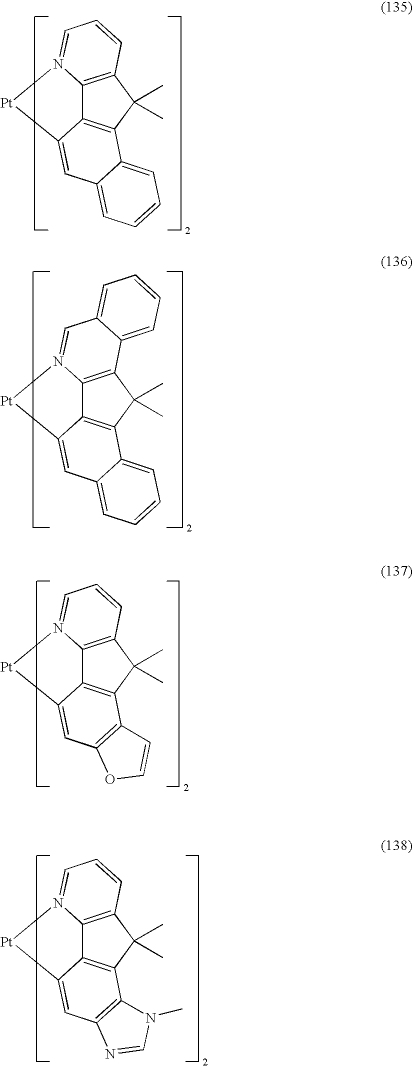

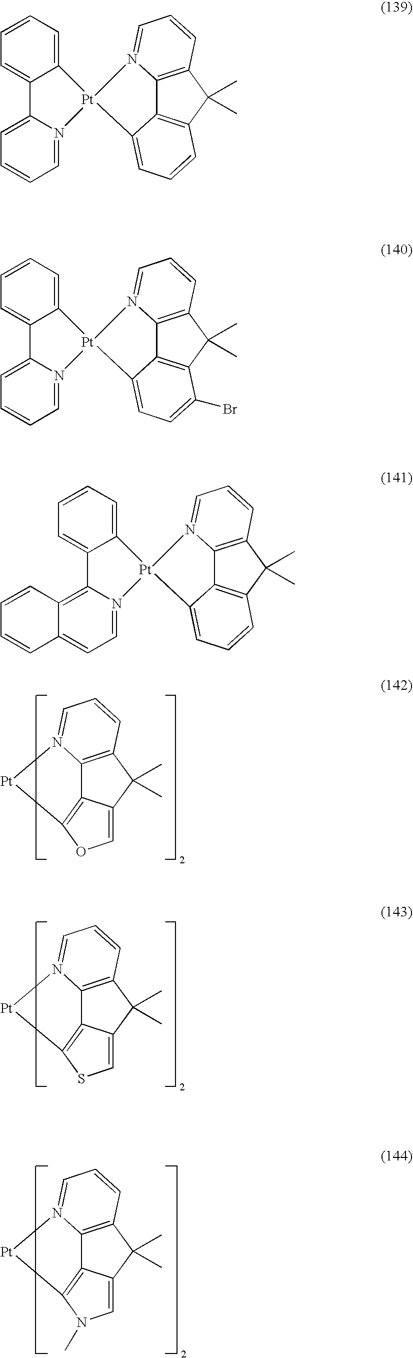

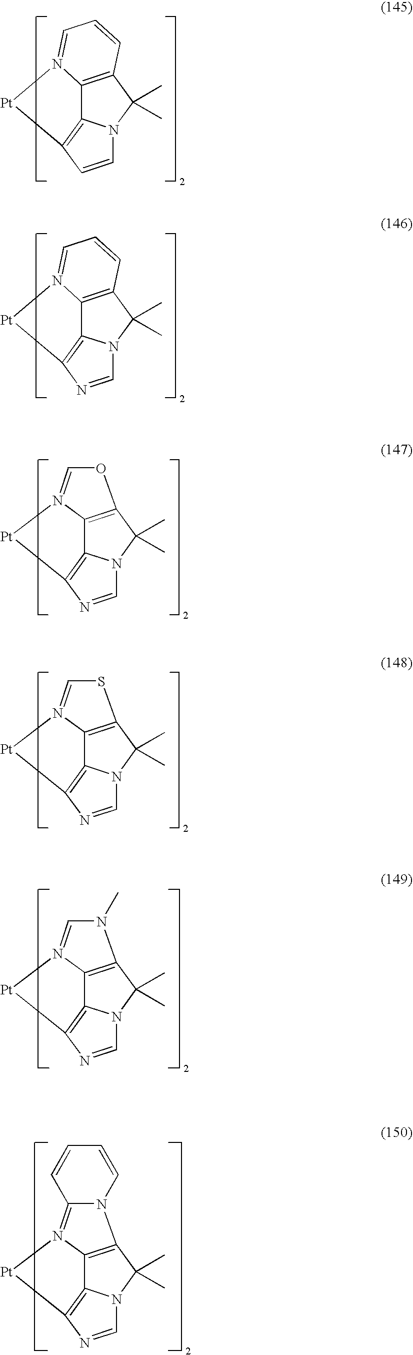

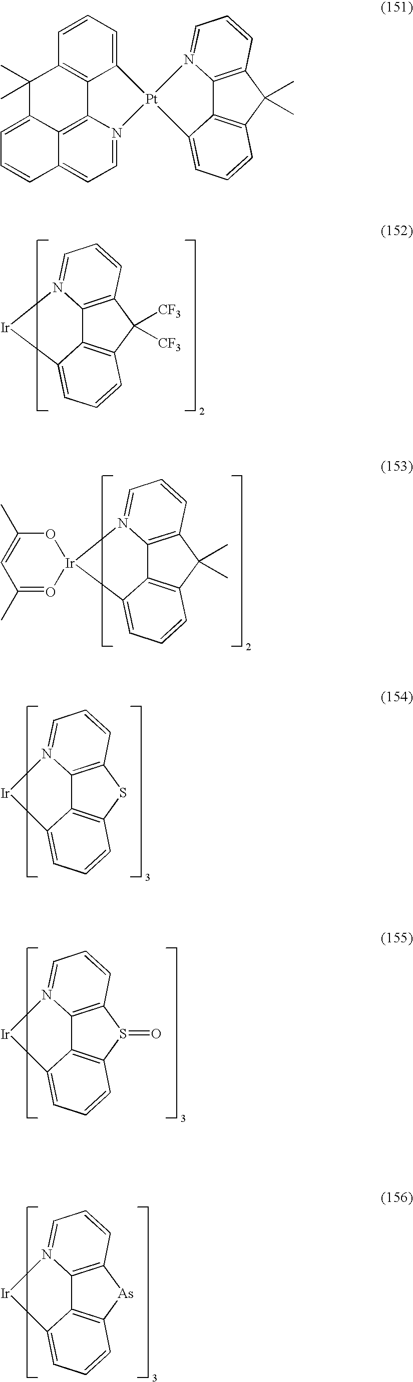

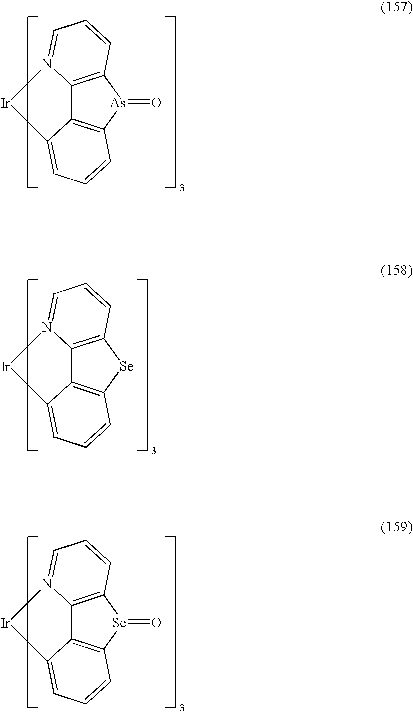

The compounds according to the invention described above, for example compounds in accordance with Examples 9, 16, 65, 84 and 91, can also be used as comonomers for the preparation of corresponding conjugated, partially conjugated or non-conjugated oligomers, polymers or dendrimers. The polymerisation here is preferably carried out via the bromine functionality. Thus, they may be copolymerised, inter alia, into polyfluorenes (for example in accordance with EP 842208 or WO 00/22026), polyspirobifluorenes (for example in accordance with EP 707020 or EP 894107), polydihydrophenanthrenes (for example in accordance with WO 05/014689), polyindenofluorenes (for example in accordance with WO 04/041901 and WO 04/113468), polyphenanthrenes (for example in accordance with WO 05/104264), poly-para-phenylenes (for example in accordance with WO 92/18552), polycarbazoles (for example in accordance with WO 04/070772 or WO 04/113468), polyketones (for example in accordance with WO 05/040302), polysilanes (for example in accordance with DE 102004023278) or polythiophenes (for example in accordance with EP 1028136), or may also be present in copolymers which contain various of these units. They can either be incorporated here into the side chain or main chain of the polymer or may also represent branching points of the polymer chains (for example in accordance with DE 102004032527.8).

The invention thus furthermore relates to conjugated, partially conjugated or non-conjugated oligomers, polymers or dendrimers comprising one or more of the compounds of the formula (1) or formula (1a), where at least one of the radicals R and R¹ defined above, preferably R¹, represents a bond to the polymer or dendrimer. For units of the formula (1) or formula (1a), the same preferences as already described above apply in polymers and dendrimers. Apart from the above-mentioned units, the oligomers, polymers or dendrimers may contain further units selected, for example, from recurring units which have hole-transport properties or electron-trans-port properties. The materials known from the prior art are suitable for this purpose.

The above-mentioned oligomers, polymers, copolymers and dendrimers are distinguished by good solubility in organic solvents and high efficiency and stability in organic electroluminescent devices.

The compounds of the formula (1) according to the invention, in particular those which are functionalised by halogens, may furthermore also be further functionalised by common reaction types and thus converted into extended compounds of the formula (1). An example which may be mentioned here is Suzuki functionalisation using arylboronic acids or Hartwig-Buchwald functionalisation using amines.

The compounds, oligomers, polymers, dendrimers or extended compounds of the formula (1) according to the invention are used as active components in organic electronic components, such as, for example, organic light-emitting diodes (OLEDs), organic integrated circuits (O-ICs), organic field-effect transistors (O-FETs), organic thin-film transistors (O-TFTs), organic solar cells (O—SCs), organic light-emitting transistors (O-LETs), organic field-quench devices (O-FQDs), light-emitting electrochemical cells (LECs) or organic laser diodes (O-lasers).

The present invention thus furthermore relates to the use of the compounds of the formula (1) according to the invention, the oligomers, polymers and dendrimers according to the invention and corresponding extended compounds of the formula (1) as active component in organic electronic components, in particular as emitting compound.

The invention furthermore relates to electronic components selected from the group of the organic and polymeric light-emitting diodes (OLEDs, PLEDs), organic field-effect transistors (O-FETs), organic thin-film transistors (O-TFTs), organic integrated circuits (O-OICs), organic solar cells (O—SCs), organic light-emitting transistors (O-LETs), organic field-quench devices (O-FODs), light-emitting electrochemical cells (LECs) and organic laser diodes (O-lasers), in particular organic and polymeric light-emitting diodes, comprising one or more compounds of the formula (1) according to the invention, oligomers, polymers and dendrimers according to the invention and corresponding extended compounds of the formula (1), in particular as emitting compound.

In particular in the case of low-molecular-weight compounds according to the invention, these are usually employed in an emitting layer together with a matrix material. The matrix material here may either be of low molecular weight or oligomeric or polymeric.

Preferred matrix materials are those based on carbazoles, for example CBP (bis(carbazolyl)biphenyl), but also other materials comprising carbazole or carbazole derivatives, for example as described in WO 00/057676, EP 1202358 and WO 02/074015. Preference is furthermore given to ketones and imines, as described, for example, in WO 04/093207, in particular those based on spirobifluorene, and phosphine oxides, phosphine selenides, phosphazenes, sulfoxides and sulfones, as described, for example, in WO 05/003253, in particular those based on spirobifluorene. Preference is furthermore given to silanes, polypodal metal complexes, for example as described in WO 04/081017, and oligophenylenes based on spirobifluorenes, for example as described in EP 676461 and WO 99/40051. Particularly preferred matrix materials are ketones, phosphine oxides, sulfoxides and sulfones. Very particular preference is given to ketones and phosphine oxides.

The compounds according to the invention have the following advantages over compounds in accordance with the prior art:
1. The compounds according to the invention are distinguished by higher temperature stability. Thus, the low-molecular-weight compounds can not only be evaporated without decomposition in a high vacuum during production of the organic electronic device, but they can also be sublimed without decomposition at elevated temperature at a greater rate for purification of the compounds. Resource-conserving use of compounds of these rare metals is thus possible.
2. Due to the steric screening of the complexes, triplet-triplet annihilation is prevented, which results in higher efficiencies.
3. The lifetime of the complexes according to the invention on use in OLEDs is better than of complexes in accordance with the prior art.
4. The compounds according to the invention are distinguished by good solubility in organic solvents, which considerably simplifies their purification by common methods, such as recrystallisation or chromatography. The compounds can thus also be processed from solution by coating or printing techniques. This property is also advantageous during conventional processing by evaporation since the cleaning of the equipment or the shadow masks employed is thus considerably simplified.

The present invention is explained in greater detail by the following examples without wishing it to be restricted thereto. The person skilled in the art will be able to prepare further compounds according to the invention or use the process according to the invention from the descriptions without inventive step.

### EXAMPLES

4-Azafluorenone (A.-S. Rebstock et al., Tetrahedron 2003, 59, 4973, M. T. DuPriest et al, J. Org. Chem. 1986, 51, 2021), 4-azafluorene (M. T. DuPriest et at, J. Org. Chem. 1986, 51, 2021), benzofuro[3,2-b]-pyridine (J. Org. Chem. 1983, 48(5), 690) and [1]benzothieno[3,2-b]pyridine (J. Chem. Soc., Perkin. Trans., 1996, 21, 2561) were synthesised as described in the literature. Sodium (bis(acetylacetonato)dichloro)iridate(III) was synthesised as described in the unpublished application EP 04019737.1.

### Example 1

### fac-Tris(4-azafluorenyl-κN,κC)iridium(III)

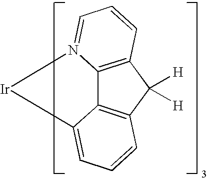

A suspension of 484 mg (1.0 mmol) of sodium (bis(acetylacetonato)dichloro)iridate(III) and 1.00 g (6.0 mmol) of 4-azafluorene in 5 ml of ethylene glycol is heated at 180° C. for 150 h. After cooling to 60° C., a mixture of 25 ml of 1 N aqueous hydrochloric acid and 25 ml of ethanol is added. The precipitated solid is filtered off with suction, washed three times with 10 ml of water and three times with 10 ml of ethanol and subsequently dried in vacuo. Yield: 243 mg (0.4 mmol), 35.2% of theory; purity: 99.5% according to NMR.

### Example 2

### fac-Tris(9,9-dimethyl-4-azafluorenyl-κN,κC)iridium(III)

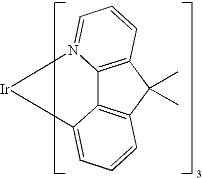

a) 9,9′-Dimethyl-4-azafluorene
16.7 g (100 mmol) of 4-azafluorene and 38.4 g (400 mmol) of sodium tert-butoxide are suspended in 300 ml of DMF. The suspension is stirred at 60° C. for 30 min., and 12.8 ml (205 mmol) of methyl iodide are then added dropwise. After the mixture has been stirred at 60° C. for 6 h, 500 ml of water are added, and the precipitated solid is filtered off, washed three times with 100 ml of water and three times with 50 ml of ethanol, dried and subsequently recrystallised once from DMF (1.5 ml/g). Yield: 14.3 g (73 mmol), 73.2% of theory; purity: 99% according to NMR.
   b) fac-Tris(9,9′-dimethyl-4-azafluorenyl-κN,κC)iridium(iII)
Procedure analogous to Example 1. Batch: 484 mg (1.0 mmol) of sodium (bis(acetylacetonato)dichloro)iridate(III), 1.17 g (6.0 mmol) of 9,9′-dimethyl-4-azafluorene. Yield: 322 mg (0.4 mmol), 41.5% of theory; purity: 99.5% according to NMR.

### Example 3

### fac-Tris(spiro(bifluoren-9,9′-(4-azafluorenyl))κN,κC)iridium(III)

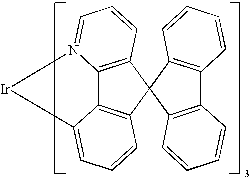

a) Spirobifluoren-9,9′-(4-azafluorene)

The corresponding Grignard reagent is prepared from 19.0 ml (110 mmol) of 2-bromobiphenyl and 2.7 g (112 mmol) of magnesium in a mixture of 100 ml of THF and 50 ml of 1,2-dimethoxyethane. This solution is added dropwise to a suspension of 18.1 g (100 mmol) of 4-azafluorenone in THF. The resultant mixture is stirred at 50° C. for 3 h and then at room temperature for 15 h. The precipitated solid is filtered off with suction, washed with a little diethyl ether and introduced into a mixture of 300 ml of acetic acid and 15 ml of conc. sulfuric acid. This mixture is refluxed for 5 h, the acetic acid is distilled off, and 200 ml of water are added to the residue. After addition of 500 ml of dichloromethane, the aqueous phase is rendered alkaline (pH>10) using saturated potassium carbonate solution, the dichloromethane phase is separated off, and the aqueous phase is re-extracted with 200 ml of dichloromethane. The combined organic phases are dried over magnesium sulfate and evaporated. The resultant oily residue is chromatographed on silica gel using dichloromethane/methanol/acetic acid (1500:100:1). Yield: 13.0 g (41 mmol), 41.1% of theory; purity: 99% according to NMR.

b) fac-Tris(spiro(bifluoren-9,9′-(4-azafluorenyl))-κN,κC)iridium(III)

Procedure analogous to Example 1. Batch: 484 mg (1.0 mmol) of sodium (bis(acetylacetonato)dichloro)iridate(II), 1.90 g (6.0 mmol) of spirobifluoren-9,9′-(4-azafluorene). Yield: 335 mg (0.3 mmol), 29.4% of theory; purity: 99.5% according to NMR.

### Example 4

### fac-Tris(benzofuro[3,2-b]pyridinyl-κN,κC)iridium(III)

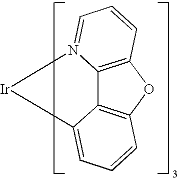 [0078] Procedure analogous to Example 1. Batch: 484 mg (1.0 mmol) of sodium (bis(acetylacetonato)dichloro)iridate(III), 1.02 g (6.0 mmol) of benzofuro-[3,2-b]pyridine. Yield: 403 mg (0.6 mmol), 57.8% of theory; purity: 99.5% according to NMR.

### Example 5

### fac-Tris([1]benzothieno[3,2-b]pyridinyl-κN,κC)iridium(III)

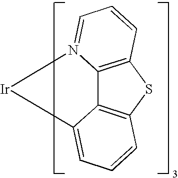

Procedure analogous to Example 1. Batch: 484 mg (1.0 mmol) of sodium (bis(acetylacetonato)dichloro)iridate(III), 1.11 g (6.0 mmol) of [1]benzothieno[3,2-b]pyridine. Yield: 458 mg (0.6 mmol), 61.5% of theory; purity: 99.5% according to NMR.

1-19. (canceled)

20. A compound of the formula (1)
M(L)ₙ(L′)ₘ(L″)ₒ Formula (1)
wherein M(L)ₙ comprises a sub-structure of the formula (2) 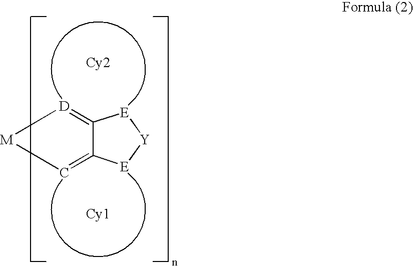
wherein
M is on each occurrence iridium, platinum, palladium, gold, tungsten, rhenium, ruthenium, or osmium;
D is, identically or differently on each occurrence, an sp²-hybridized heteroatom having a non-bonding electron pair which coordinates to M;
C is on each occurrence an sp²-hybridised carbon atom which bonds to M;
E is, identically or differently on each occurrence, an sp²-hybridised carbon or nitrogen atom;
Y is, identically or differently on each occurrence, CR₂, C(═O), C(═NR), C(═N—NR₂), C(═CR₂), SiR₂, O, S, S(═O), S(═O)₂, Se, NR, PR, P(═O)R, AsR, As(═O)R, or BR;
Cy1 is, identically or differently on each occurrence, an optionally R¹-substituted homo- or heterocycle which bonds to M via an sp²-hybridised carbon atom;
Cy2 is, identically or differently on each occurrence, an optionally R¹-substituted heterocycle which coordinates to M via the atom D;
R is, identically or differently on each occurrence, H; F; CN; a straight-chain alkyl or alkoxy group having up to 40 C atoms; a branched or cyclic alkyl or alkoxy group having 3 to 40 C atoms; wherein one or more non-adjacent CH₂ groups of said straight-chain alkyl or alkoxy groups or branched or cyclic alkyl or alkoxy groups are optionally replaced by —R²C═CR²—, —C≡C—, Si(R²)₂, Ge(R²)₂, Sn(R²)₂, —O—, —S—, —NR²—, —(C═O)—, —(C═NR²)—, —P═O(R²)—, or —CONR^{e}— and wherein one or more H atoms of said straight-chain alkyl or alkoxy groups or branched or cyclic alkyl or alkoxy groups are optionally replaced by F; or an aromatic or heteroaromatic system or an aryloxy or heteroaryloxy group having up to 30 C atoms optionally substituted by one or more radicals R¹; and wherein two R optionally define an aliphatic or aromatic ring system;
R¹ is, identically or differently on each occurrence; H; F; Cl; Br; I; OH; NO₂; CN; N(R²)₂; a straight-chain alkyl or alkoxy group having up to 40 C atoms; a branched or cyclic alkyl or alkoxy group having 3 to 40 C atoms; wherein one or more non-adjacent CH₂ groups of said straight-chain alkyl or alkoxy groups or branched or cyclic alkyl or alkoxy groups are optionally replaced by —R²C═CR²—, —C≡C—, Si(R²)₂, Ge(R²)₂, Sn(R²)₂—O—, —S—, —NR²—, —(C═O)—, —(C—NR²)—, —P═O(R²)—, —COOR²—, or —CONR²— and wherein one or more H atoms of said straight-chain alkyl or alkoxy groups or branched or cyclic alkyl or alkoxy groups are optionally replaced by F; or an aromatic or heteroaromatic system or an aryloxy or heteroaryloxy group having up to 30 C atoms substituted by one or more non-aromatic radicals R¹, wherein a plurality of R¹, either on the same ring or on different rings, optionally define a mono- or polycyclic, aliphatic or aromatic ring system;
R² is, identically or differently on each occurrence, H or an aliphatic or aromatic hydrocarbon radical having up to 20 C atoms;
n is 1,2, or 3;
L′ and L″
are monoanionic, bidentate-chelating ligands; and
m and o
are, identically or differently on each occurrence, 0, 1, or 2.

21. The compound of claim 20, wherein Cy1 and Cy2 are aromatic or heteroaromatic systems.

22. The compound of claim 21, wherein M(L)ₙ comprises a sub-structure of the formula (2a) 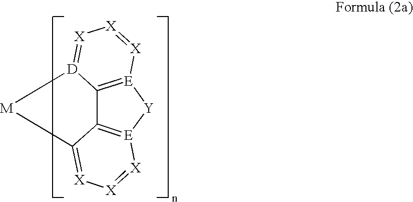
wherein
D is, identically or differently on each occurrence, nitrogen or phosphorus;
X is, identically or differently on each occurrence, CR¹, N, or P; or (X—X) or (X═X) is NR¹, S, or O; or if E in the corresponding ring is N, (X—X) or (X═X) is CR¹, N, or P; and
E is, identically or differently on each occurrence, C or N, with the proviso that if the E is N, precisely one unit X—X in the corresponding ring is CR¹, N, or P.

23. The compound of claim 22, wherein M(L)ₙ comprises at least one sub-structure of the formula (2b) 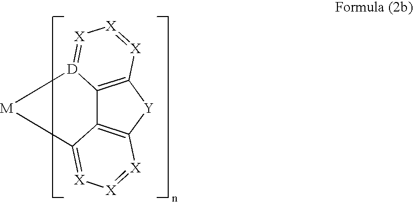
and optionally further comprises a sub-structure M(L′)ₙ of the formula (3) 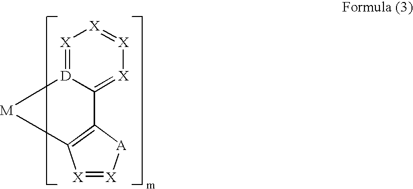
wherein
X is, identically or differently on each occurrence, CR¹, N, or P; or (X—X) or (X═X) is NR¹, S, or O; and
A is, identically or differently on each occurrence, —CR¹═CR¹—, —N═CR¹—, —P═CR¹—, —N═N—, —P═N—, NR¹, O, or S;
with the proviso that each of the two rings is a five- or six-membered ring.

24. The compound of claim 20, wherein monoanionic, bidentate ligands L″ are selected from the group consisting of 1,3-diketonates derived from 1,3-diketones, 3-ketonates derived from 3-ketoesters, carboxylates derived from aminocarboxylic acids, salicyliminates derived from salicylimines, and borates of nitrogen-containing heterocycles.

25. The compound of claim 20, wherein n is 2 or 3.

26. The compound of claim 25, wherein m and o are 0.

27. The compound of claim 20, wherein Y is CR₂, C(═O), C(═CR₂), O, S, NR, PR, P(═O)R, or BR.

28. The compound of claim 27, wherein L is a spiro compound and Y is CR₂, wherein the C of said CR₂ is a spiro atom.

29. The compound of claim 27, wherein L is a derivative of azaspirobifluorene.

30. The compound of claim 20, wherein D is N.

31. The compound of claim 20, wherein X is CR¹.

32. A process for preparing the compound of claim 20 comprising reacting the corresponding free ligands with metal alkoxides of the formula (4), with metal ketoketonates of the formula (5) or mono- or polynuclear metal halides of the formulae (6), (7), or (8) 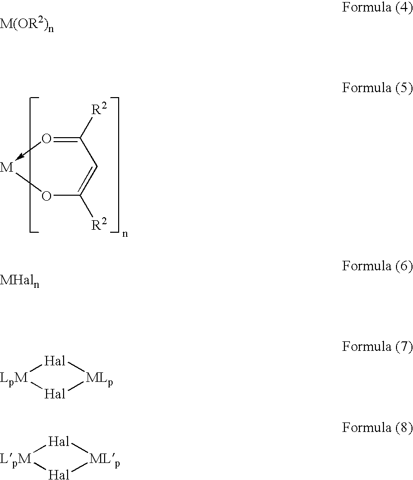
wherein p is 1 for divalent metals, p is 2 for trivalent metals, and Hal is F, Cl, Br, or I.

33. The process of claim 32, wherein metal compounds which carry alkoxide and/or halide and/or hydroxyl radicals and also ketoketonate radicals are used, wherein said metal compounds are optionally charged.

34. A conjugated, partially conjugated, or non-conjugated oligomer, polymer, or dendrimer comprising one or more compounds according to claim 20, wherein at least one of R and R¹ represents a bond to the polymer or dendrimer.

35. The conjugated, partially conjugated, or non-conjugated oligomer, polymer, or dendrimer of claim 34, wherein said conjugated, partially conjugated, or non-conjugated oligomer, polymer, or dendrimer is selected from the group consisting of polyfluorenes, polyspirobifluorenes, polydihydrophenanthrenes, polyindenofluorenes, polyphenanthrenes, poly-para-phenylenes, polycarbazoles, polyketones, polysilanes, polythiophenes, and copolymers thereof.

36. An organic electronic component comprising one or more compounds according to claim 20.

37. An organic electronic component comprising one or more conjugated, partially conjugated, or non-conjugated oligomer, polymer, or dendrimer according to claim 34.

38. The organic electronic component of claim 36, wherein said component is selected from the group consisting of organic and polymeric light-emitting diodes, organic field-effect transistors, organic thin-film transistors, organic integrated circuits, organic solar cells, organic light-emitting transistors, organic field-quench devices, light-emitting electrochemical cells, and organic laser diodes.

39. The organic electronic component of claim 37, wherein said component is selected from the group consisting of organic and polymeric light-emitting diodes, organic field-effect transistors, organic thin-film transistors, organic integrated circuits, organic solar cells, organic light-emitting transistors, organic field-quench devices, light-emitting electrochemical cells, and organic laser diodes.
